(19) United States
(12) Patent Application Publication
(10) Pub. No.: US 2002/0143654 A1
(43) Pub. Date: Oct. 3, 2002

(54) Method and system that enables a telecom initiator to instantly compensate a receiving party

(75) Inventors: Kuansan Wang, Brewster, NY (US); John F. Pitrelli, Danbury, CT (US)

Correspondence Address: CHARLES N.J. RUGGIERO, ESQ., OHLANDT, GREELEY, RUGGIERO & PERLE, L.L.P., 10th FLOOR, ONE LANDMARK SQUARE, STAMFORD, CT, 06901-2682, US

(73) Assignee: NYNEX SCIENCE AND TECHNOLOGY, INC.

(21) Appl. No.: 10/076,823

(22) Filed: Feb. 15, 2002

Related U.S. Application Data
(63) Continuation of application No. 08/826,139, filed on Mar. 27, 1997.

(51) Int. Cl. G06F 17/60

(52) U.S. Cl. 705/26

(57) ABSTRACT

A telecommunication system includes a communication network having a plurality of switches that are coupled between at least one transaction server, a plurality of receiver premises and a plurality of marketer premises. The transaction server includes memory for storing receiver data corresponding to a receiver identifier and a processor unit. The transaction server further includes a control mechanism to operate the switches to establish communication pathways between any marketer premises and any receiver premises. In the operation of the invention, the transaction server receives a receiver identifier and offer terms from a marketer premises, establishes a communication pathway with a receiver premises corresponding to the receiver identifier and asks if the receiver premises wishes to receive information from the marketer premises. Upon an acceptance, the transaction server enables provision of the information.

### FIELD OF INVENTION

The present invention relates to a telecommunication system which provides facilities for interactive marketing and user response facilities and, more particularly, to a system wherein a communication service provider controls transactions between a marketer to a receiving party.

### BACKGROUND OF THE INVENTION

Telemarketing provides an important source of revenue for many product and service related industries. For that reason, telemarketers constantly search for low cost marketing strategies which appeal to customers.

A common telemarketing technique is for a telemarketer to call a receiving party (i.e., a customer) at a place of residence, business, . . . etc. in order to solicit business. Upon a connection, the telemarketer attempts to provide the receiving party with promotional information such as product or service advertisements. In most cases, the receiving party, however, finds such calls intrusive and irritating because they are neither timely, interesting nor trustworthy. That is to say, the receiving party has no control over the receipt of telemarketer calls (i.e., the time, place, type of telemarketing information, . . . etc.), and cannot verify the identity or trustworthiness of the telemarketer.

Some receiving parties also feel that telemarketer calls are a waste of time because they do not receive a benefit in return for receiving promotional information. As a result, receiving parties often refuse to receive promotional information.

To remedy the latter problem, telemarketers now offer the receiving party as an incentive, some type of compensation, in return for receiving promotional information or responding to an inquiry. The compensation is typically in the form of a check for a certain monetary sum, a rebate, a coupon . . . etc. which is sent to the receiving party, via mail. However, there is little assurance that the receiving party will receive the compensation because telemarketers only provide customers with verbal assurance of a compensation. Thus, the receiving parties have no way to verify the trustworthiness or good faith of a telemarketer. Even where the telemarketer is forthcoming, the customer must also wait for the receipt of the compensation, i.e., over the mail.

The current telemarketing method is also disadvantageous to the telemarketer. One problem is associated with the labor intensive nature of the method. Mainly, the efficiency and cost of running a telemarketing business depends on the ability of the worker, i.e., the salesperson. Another problem is associated with the costs involved in providing compensation to receiving parties. Telemarketers incur costs in sending compensation to customers, i.e., via mail, and processing such compensation.

One approach to improving the manner of compensation is to utilize electronic channels, such as credit cards or bank accounts which allow a telemarketer to directly compensate a receiving party. Such a method, however, requires the receiving party to reveal personal information, i.e., an account number, that is not in the public domain and is easily subjected to abuse. Therefore, the utilization of such electronic channels poses a high security risk for the customer.

There is a continuing desire to develop a low cost telemarketing system which provides greater flexibility to the receiving party and the telemarketer.

Accordingly, it is an object of the present invention to provide a telecommunication system, wherein a trusted communication provider mediates transactions between a telemarketer and a receiving party.

It is a further object of the invention to provide a telecommunication system wherein a receiving party receives only those transactional offers that correspond to receiving criteria.

Another object of the invention is to provide a telecommunication system which provides greater security to the receiving party.

It is a further object of the invention to provide a telecommunication system which can automatically credit a monetary sum into a receiver account, in response to an offer confirmation by the receiver premises.

### SUMMARY OF THE INVENTION

A telecommunication system includes a communication network having a plurality of switches that are coupled between at least one transaction server, a plurality of receiver premises and a plurality of marketer premises. The transaction server includes memory for storing receiver data corresponding to a receiver identifier and a processor unit. The transaction server further includes a control mechanism to operate the switches to establish communication pathways between any marketer premises and any receiver premises. In the operation of the invention, the transaction server receives both a receiver identifier and offer terms from a marketer premises, establishes a communication pathway with a receiver premises corresponding to the receiver identifier and asks if the receiver wishes to receive promotional information from the marketer premises. Upon an acceptance, the transaction server enables provision of the promotional information.

The present invention also provides a telecommunication system which allows a marketer to directly compensate a receiving party, via the transaction server, for agreeing to receive promotional information. Upon an acceptance by the receiver premises to receive promotional information, the transaction server credits a monetary sum (i.e., some compensation) to a receiver account associated with the receiving party. Therefore, the marketer can provide an additional incentive, in the form of some compensation, to the receiver premises for receiving the promotional information; and the receiver premises is assured of receiving the promised compensation.

### BRIEF DESCRIPTION OF THE DRAWINGS

FIG. 1 is a block diagram of a telecommunication system which includes a transactional server that cooperates with a plurality of receiver premises and marketer premises to provide selected services thereto.

FIG. 2 is a schematic diagram of a customer database accessible to the transaction server.

FIG. 3 is a schematic diagram of a preference database accessible to the transaction server.

FIG. 4 illustrates a logic flow diagram of the operation of the present invention.

FIG. 5 illustrates a logic flow diagram of Customer Preference feature in accordance with the present invention.

FIG. 6 is a block diagram of a telecommunication system which includes at least two transactional servers that cooperate with a plurality of receiver premises and marketer premises to provide selected services thereto.

### DETAILED DESCRIPTION OF THE INVENTION

Before proceeding with a detailed description of a preferred embodiment of the present invention, it is well to define certain terms as used herein. The term “marketer premises” will be used hereafter to refer to a telemarketer, a survey conductor, or any individual or business offering promotional information either with or without compensation to a receiving party or requesting answers to inquiries. Marketer premises will also refer to any entity initiating communication (i.e., an initiating party) with a receiving party in order to conduct a transaction.

The term “promotional information” will be used hereafter to refer to product and service advertisements, survey inquiries, . . . etc.

The term “transactional offer” will be used hereafter to refer to an offer made by a marketer premises to a receiver premises, wherein the receiver premises is asked to perform some activity.

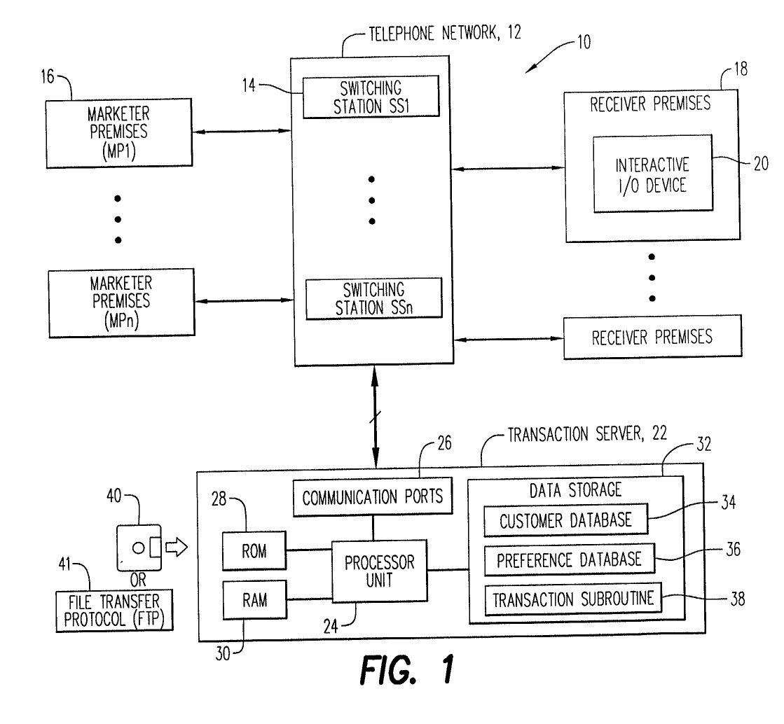

Referring to FIG. 1, a telecommunication system 10 includes a telephone network 12 (i.e., a circuit switch network), having a plurality of switches 14 coupled between a plurality of receiver premises 18, a plurality of marketer premises 16 and a transaction server 22. Transaction server 22 (i.e., a telephone provider) controls the operation of the switches to establish communication pathways between any receiver premises, any marketer premises and transaction server 22. Telephone network 12 is well known in the art and will not be described in detail herein.

Receiver premises 18 includes an interactive input/output device 20 for receiving downstream information and transmitting upstream information, across telephone network 12. Specifically, each input/output device 20 is provided with means for receiving a user input (i.e., via a key pad, a voice response device, . . . etc.) which is transmitted to a designated recipient, in this case, either marketer premises 16 or transaction server 22. Each input/output device 20 is further capable of receiving downstream information from either marketer premises 16 or transaction server 22 and outputting such information (over a speaker, video display, . . . etc.) to a user at receiver premises 18.

Interactive input/output device 20 may take the form of a voice response device (i.e., a telephone), a video conferencing device, a personal computer with a modem or any device that allows receiver premises to communicate across telephone network 12 with either marketer premises 16 or transactional server 22. Input/output device 20 may also include a caller identification (ID) unit for identifying the source of an incoming data transmission.

Transaction server 22 includes a transaction processor subroutine 38 which is stored therein, or which can be loaded thereinto via a magnetic disk 40 or a file transfer protocol (FTP). The transaction processor subroutine 38, in combination with the transaction server hardware, provides accounting services for marketer premises 16 and receiver premises 18, mediates transactions between marketer premises 16 and receiver premises 18, updates connected databases, controls communication pathways between marketer premises 16 and receiver premises 18, and transmits transactional offers from marketer premises 16 to receiver premises 18. Transaction server 22 further processes input signals received from either marketer premises 16 or receiver premises 18.

Transaction server 22 further includes a processor unit 24 which is coupled to a random access memory (RAM) 30, a read only memory (ROM) 28 and communication ports 26 which provide interconnection to telephone network 12. A data storage device 32 provides memory capacity for a transaction processor subroutine 38, a customer database 34 and a customer preference database 36. Instead of storing customer database 34 and customer preference database 36 locally, such database can be stored at an accessible, external location such as a central office, another transaction server, . . . etc. Note that while transaction processor subroutine 38 is indicated as a software driven process, it can also be configured as hardware.

Note that transaction server 22 is a trusted entity as distinguished from an unknown marketer. That is to say, receiver premises 18 is familiar with transaction server 22 and has reason to believe that any transaction (from a marketer) mediated by transaction server 22 will be legitimate. It is preferred that transaction server 22 be associated with or operated by a telephone company, internet provider or any entity trusted by receiver premises 18.

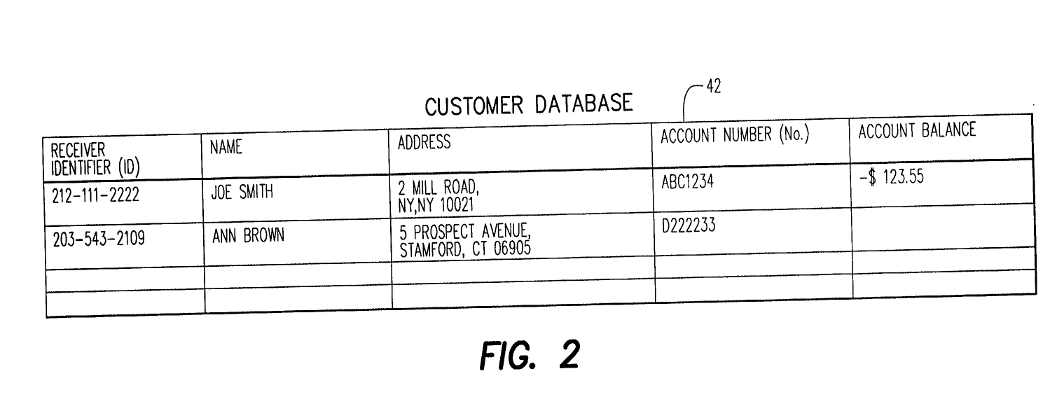

A schematic showing of customer database 34 is found in FIG. 2 and preferably includes the following data:

Receiver Identification (ID) Number;

Name;

Address;

Account Number (No.);

Account Balance;

Most of the contents of customer database 34 is self-explanatory and requires no further description. The “Account Balance” indicates a monetary sum credited or debited to a corresponding receiver premises.

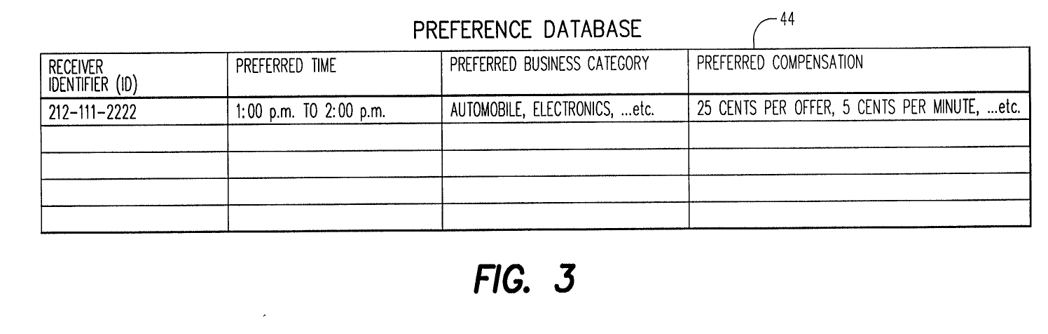

Preference database 36 is illustrated, schematically, in FIG. 3 and includes Receiver Identification (ID) Number, Preferred Time, Preferred Category and Preferred Compensation. The Preferred Time indicates when a receiver premises prefers to receive transactional offers from any marketer premises, i.e., 4:00 p.m. to 5:00 p.m. The Preferred Category relates to the particular type of transactional offer that receiver premises is willing to receive. Finally, the Preferred Compensation indicates the amount of compensation that receiver premises prefers to receive.

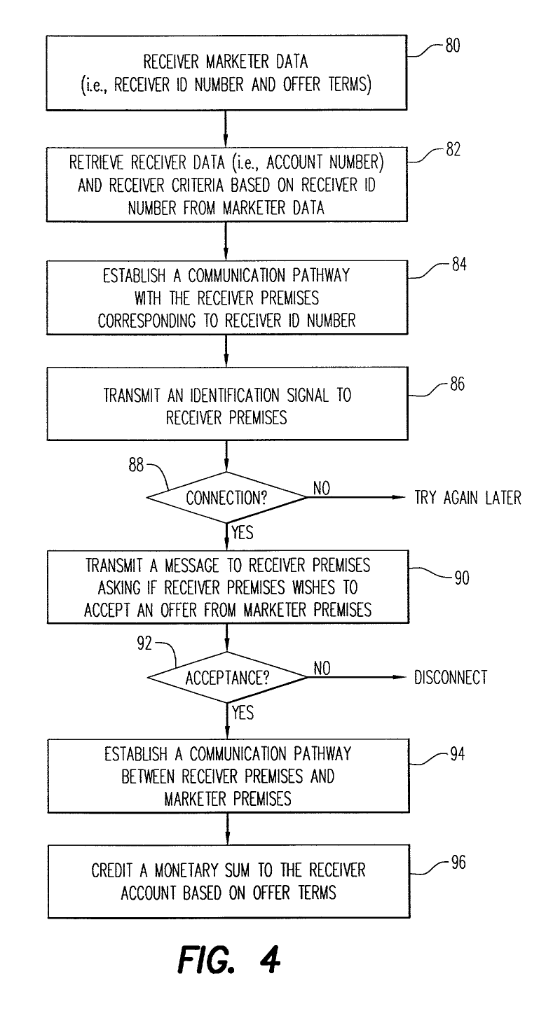

Referring to FIG. 4, the operation of telecommunication system 10 will be described. Initially, transaction server 22 has had loaded and stored therein customer database 34, preference database 36 and transaction subroutine 38. Such stored database and subroutine enable transaction server 22 to selectively provide and mediate transactional offers from any marketer premises to any receiver premises 18.

Thereafter, transaction server 22 receives and analyzes marketer data, which includes at least a receiver ID Number and offer terms, that originate from marketer premises 16 (Box 80). The marketer data may be maintained locally in a marketer database and retrieved for use in the operation of the invention, or may be received from an external source such as marketer premises 16, another transaction server servicing other receiver premises and marketer premises, a central office, . . . etc.

In response to the receipt of marketer data, transaction server 22 accesses customer database 34 and retrieves a receiver account and a receiver criteria associated with a receiver premises corresponding to the receiver ID number (Box 82). Transaction server 22 then establishes a communication pathway to receiver premises 18 corresponding to the receiver ID number (Box 84). At this point, transaction server 22 transmits an identification signal to receiver premises 18 causing interactive input/output device 20 (i.e., telephone) to generate an output that signals an incoming transactional offer (Box 86).

It is important to understand that such an output provides receiver premises 18 with notice that a transactional offer is being transmitted and that the offer will be mediated by transaction server 22. Such an output may take the form of a ring tone having a certain pitch and frequency, a message displayed on a caller ID unit or display screen, or any other type of output so long as receiver premises 18 can distinguish between an incoming transactional offer from transaction server 22 and other incoming transmissions. That is to say, receiver premises 18 will know that the incoming transmission is a transactional offer which allows receiver premises 18 either to receive the transactional offer (i.e., picking up the telephone receiver) or to terminate the transmission at the outset (i.e., ignoring the telephone call or hanging up). Receiver premises 18 can also identify the source of the incoming offer and is assured that any transactions conducted thereon will be mediated by a trustworthy third-party, namely transaction server 22.

Thereafter, upon a connection (Box 88), transaction server 22 sends a message to receiver premises 18 which asks if receiver premises 18 wishes to accept a transactional offer from marketer premises 16 to receive promotional information and/or to respond to an inquiry or inquiries (Box 90). If receiver premises 18 transmits an offer confirmation (i.e., an acceptance) to transaction server 22 (box 92), transaction server 22 establishes a communication pathway between marketer premises 16 and receiver premises 18 (Box 94). Marketer premises 16 can then transmit promotional information to receiver premises 18, over telephone network 12, and, likewise, receive responses from receiver premises 18.

Note that the receipt of promotional information may also be conditioned upon some form of compensation, preferably a monetary sum. As part of the transactional offer, transaction server 22 asks if receiver premises 18 wishes to receive promotional information in return for a monetary sum (i.e., a credit). After an acceptance by receiver premises 18, transaction server 22 then credits a monetary sum to the receiver account (Box 96). Transaction server 22 can credit the receiver account upon a receiver acceptance, upon a termination of the communication pathway by either party or at any time therebetween. The credited sum may be based on a single transaction, the length of the transaction (i.e., 25 cents per minute), . . . etc.

Transaction server 22 also debits a monetary sum to a marketer account, corresponding to marketer premises 16. As with the receiver accounts, the marketer accounts may either be stored locally in a marketer database or accessed from an external source.

Processor unit 24 and transaction processor subroutine 38 may be adapted to further provide a marketer protection feature. The marketer protection feature conditions a receipt of the monetary sum upon receiver premises 18 receiving the entire promotional information (i.e., staying on line for the entire presentation of the promotional information) or affirmatively interacting with marketer premises 16 (i.e., question/response) during the presentation.

The latter action is a protection feature which ensures marketer premises 16 that receiver premises 18 is paying attention to the presentation of the promotional information. Such an arrangement can be implemented by simply requesting a response from receiver premises 18 at different time intervals during the presentation. For instance, receiver premises 18 may be asked every minute or at the end of the presentation to respond to a question. A failure to respond or an incorrect response by receiver premises 18 would result in the termination of the agreement and no payment to receiver premises 18.

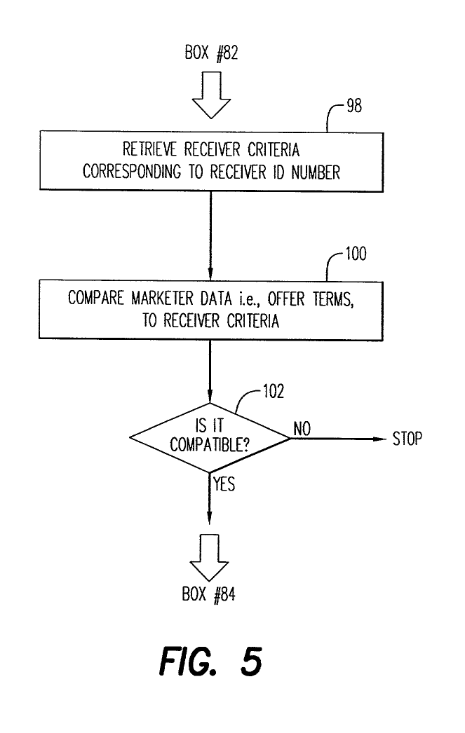

Transaction server 22 in conjunction with transaction processor subroutine 38 may also provide a Customer Preference feature to screen incoming marketer offers and to transmit only those offers that meet a receiver criteria to receiver premises 18. As shown in FIG. 5, after accessing customer database 34 (Box 82), transaction server 22 retrieves additional receiver data, corresponding to the receiver ID number and contained in preference database 36 (i.e., the preferred time, preferred category and preferred compensation) (Box 98). Transaction server 22 compares the preferences of the receiver to the offer terms of marketer premises 16 and any other significant factor (Box 100) and determines whether the offer terms are compatible to the receiver criteria (Box 102). For instance, a receiver premises corresponding to receiver ID number 212-111-2222 (FIG. 3) is only sent transactional offers, between the hours of 1:00 p.m. and 2:00 p.m., which relate to automobiles or electronics and provide at least compensation in the amount of 25 cents per offer or 5 cents per minute. As can be appreciated by those skilled in the art, transaction server 22 transmits only those transactional offers that are compatible to the receiver criteria to receiver premises 18.

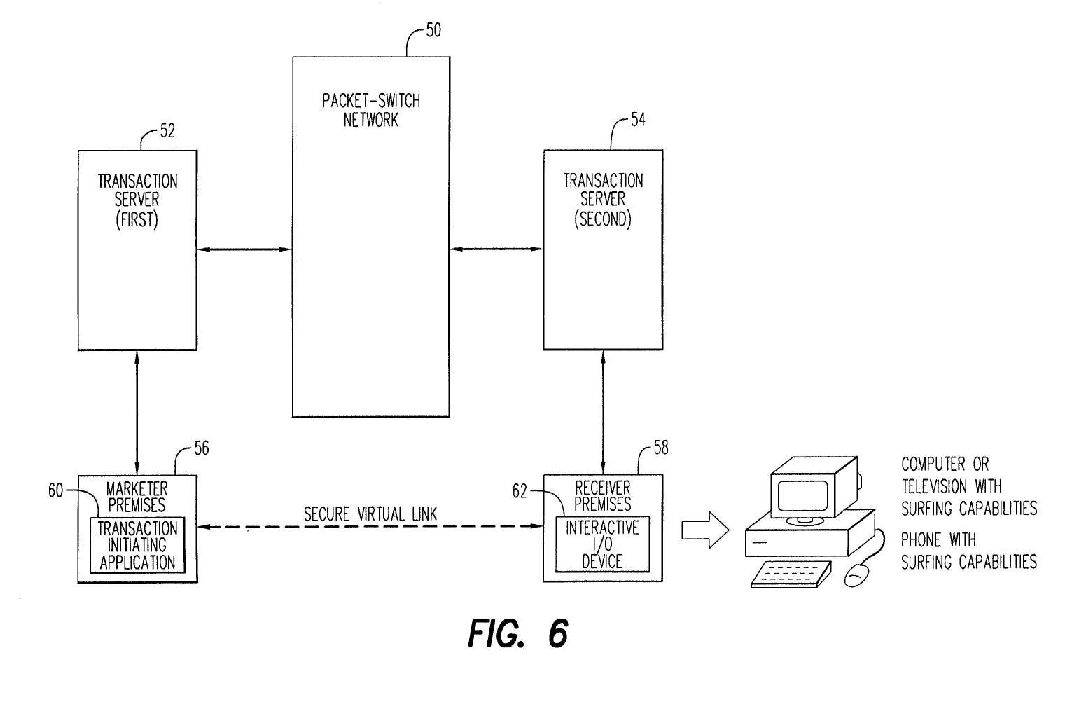

In a second embodiment of the present invention, telecommunication system 10 includes a packet switch network, instead of telephone network. As shown in FIG. 6, a packet switch network 50 is coupled between a first transaction server 52 (i.e., an internet service provider) and a second transaction server 54 for allowing data communications therebetween. First transaction server 52 is connectable to marketer premises 56. Second transaction server 54 is connectable to receiver premises 58. Each transaction server 52, 54 is capable of operating packet switch network 50 to establish communication pathways between any marketer premises, subscriber premises and transaction server. Packet switch network 50 is well-known in the art and will not further be described herein.

Note that transaction servers 52, 54, marketer premises 56 and receiver premises 58 include the same hardware and software as described in the first embodiment, except that marketer premises 56 further includes a communication subroutine 60 which is stored therein. The communication subroutine 60, in combination with marketer hardware (i.e., a processor unit), allows marketer premises 56 to initiate the transmission of marketer data (i.e., receiver ID number and offer terms) to receiver premises 58, via transaction servers 52, 54 and to receive incoming data from receiver premises 58 and transaction servers 52, 54.

The operation of the invention is generally the same as that described in the first embodiment, except that a transaction between marketer premises 56 and receiver premises 58 is controlled and mediated by at least two transaction servers 52, 54. For example, marketer premises 56 initially transmits marketer data (i.e., via electronic mail, . . . etc.), which includes at least a receiver ID number and offer terms, to first transaction server 52 (i.e., an internet provider). Instead of transmitting the marketer data to transaction server 52, the marketer data can be stored locally at transaction server 52 and retrieved during the operation of the invention.

Thereafter, first transaction server 52 analyzes the receiver ID Number and identifies the service provider, i.e., second transaction server 54, servicing a receiver premises 58 corresponding to the receiver ID. First transaction server 52 then transmits the marketer data to second transaction server 54.

Second transaction server 58 then sends the transactional offer from marketer premises 56. In the event of an acceptance by receiver premises 58, a communication pathway (i.e., a secure virtual link or hyperlink) is established between marketer premises 56 and receiver premises 58. Marketer premises 56 can then transmit downstream promotional information to and receive upstream responses from receiver premises 58, across the communication pathway.

Note that while not shown in FIG. 1 or 6, telecommunication system 10 may include a plurality of transaction servers which are connectable to a plurality of marketer premises and receiver premises. Each transaction server may also include the Customer preference and marketer protection features as described above. Each transaction server is capable of connecting to another server in order to complete a transaction, and/or mediating a transaction between a marketer premises and a receiver premises (as described above) upon a request from another server.

It is also important to understand that a transaction server in accordance with the present invention can mediate any type of transaction or transactional offer that involves compensating a receiving party (i.e., not only those involving promotional information). As described above, upon an acceptance of an offer, the transaction server can simply credit a monetary sum to a receiver account corresponding to the receiving party (i.e., instant compensation), based on the marketer's offer terms.

In summary, the present invention provides a telecommunication system wherein a transaction server (i.e., a trustworthy third-party) mediates transactional offers from a marketer premises to a receiving premises. The present invention also allows a receiver premises to be automatically compensated for agreeing to receive such promotional information. Such a system may be utilized in conjunction with a telephone network, a packet switch network or a combination thereof.

The invention having thus described with particular reference to the preferred forms thereof, it will be obvious that various changes and modifications may be made therein without departing from the spirit and scope of the invention as defined in the appended claims.

1. A telecommunication system wherein a transaction server means mediates a transactional offer from a marketer to a receiving party, said telecommunication system comprising:
a communication network connected between at least one transaction server means, a plurality of receiver premises and a plurality of marketer premises and having switch means for establishing communication pathways between said transaction server means, any receiver premises and any marketer premises;
each receiver premises including an input/output means for receiving messages from said transaction server means and for receiving responses to said messages from a user for transmission to said transaction server means;
each marketer premises being capable of transmitting a receiver identifier and offer terms to said transaction server means; and
said transaction server means comprising:
memory means for storing receiver identifiers and receiver accounts corresponding to each receiver premises;
control means for causing operation of said switch means to connect said marketer premises to said receiver premises to allow data transfer therebetween; and
processor means for:
(i) receiving said receiver identifier and said offer terms from a marketer premises, and providing to an input/output means at said receiver premises, corresponding to said receiver premises, an offer to provide information from said marketer premises; and
(ii) responsive to an input from a user at said receiver premises indicating an acceptance of said offer, for enabling provision of said information.

2. A telecommunication system as recited in claim 1, wherein said transaction server means further provides a monetary sum to said receiver premises in return for receiving said information, said processor means, responsive to said input at said receiver premises indicating said acceptance of said offer, further crediting said monetary sum to a receiver account associated with said receiver premises.

3. A telecommunication system as recited in claim 1, wherein said processor means, in response to receipt of said receiver identifier, causes said input/output means at said receiver premises to signal that said transaction server means is transmitting said offer to said receiver premises.

4. A telecommunication system as recited in claim 3, wherein said processor means causes said input/output means to generate a distinct ring signal.

5. A telecommunication system as recited in claim 1, wherein said input/output means is a voice response device.

6. A telecommunication system as recited in claim 3, wherein said input/output means further includes a display means for displaying incoming messages, said processor means causing said display means to display a message identifying said transaction server as a source of transmission.

7. A telecommunication system as recited in claim 6, wherein said display means is a caller Identification (ID) unit for identifying a source of any incoming transmissions received by said input/output means.

8. A telecommunication system as recited in claim 1, wherein said processor means selectively transmits only offers from said marketer premises that are compatible with a receiver criteria, to said receiver premises, said transaction server means further including memory means for storing receiver criteria corresponding to each receiver premises.

9. A telecommunication system as recited in claim 1, wherein said communication network is a circuit-switch.

10. A telecommunication system as recited in claim 1, wherein said communication network is a packet-switch network.

11. A telecommunication system as recited in claim 1, wherein said communication network is a combination of a packet switch network and a circuit-switch network.

12. A telecommunication system as recited in claim 1, wherein said transaction server means is capable of connecting to another transaction server means to establish a communication pathway between said marketer premises and said receiver premises.

13. A transaction server, connectable to a plurality of marketer premises and receiver premises across a communication network having switch means, for mediating a transaction between a marketer premises and a receiver premises, each marketer premises capable of transmitting a receiver identifier and offer terms to said transaction server, each receiver premises including input/output means for receiving messages from said transaction server and for receiving responses from a user which are transmitted to said transaction server, said transaction server comprising:
access means for retrieving stored receiver identifiers and receiver accounts corresponding to receiver premises;
control means for causing operation of said switch means to selectively connect said marketer premises to said receiver premises to allow data transfer therebetween; and
processor means (i) for receiving a receiver identifier and offer terms, as transmitted from a marketer premises, and providing to an input/output means at said receiver premises, an offer to provide information from said marketer premises; and (ii) responsive to an input from said user at said receiver premises indicating an acceptance of said offer, for enabling provision of said information.

14. A transaction server as recited in claim 13, wherein said transaction server means further offers a monetary sum to said receiver premises in return for receiving said information, said processor means, responsive to said input at said receiver premises indicating said acceptance of said offer, crediting said monetary sum to a receiver account associated with said receiver premises.

15. A transaction server as recited in claim 13, wherein said processor means, in response to a receipt of said receiver identifier, causes said input/output means at said receiver premises to signal that said transaction server is transmitting said offer to said receiver premises.

16. A transaction server as recited in claim 13, wherein said processor means selectively transmits only offers from said marketer premises that are compatible with a receiver criteria to said receiver premises, said transaction server further including memory means for storing receiver criteria corresponding to each receiver premises.

17. A transaction server as recited in claim 16, wherein said transaction server further includes access means for retrieving receiver criteria corresponding to each receiver premises.

18. A method for enabling transaction server means, connectable to a plurality of marketer premises and receiver premises across a communication network having switch means, to provide a transactional offer from a marketer premises to a receiver premises, each receiver premises including input/output means for receiving messages from said transaction server means and for receiving responses from a user which are transmitted to said transaction server means, each marketer premises capable of transmitting a receiver identifier, said transaction server including memory means for storing receiver identifiers and receiver accounts corresponding to said receiver premises, the method comprising the steps of:
a) receiving a receiver identifier and offer terms that originated from said marketer premises;
b) selecting a receiver premises and a receiver account from said memory means based on said receiver identifier;
c) providing to said input/output means of said receiver premises, an offer to provide information from said marketer premises; and
d) in response to an input from said user indicating acceptance of said offer, enabling provision of said information.

19. A method as recited in claim 16, wherein step d) further includes crediting a monetary sum to a receiver account corresponding to said receiver premises, in response to said input from said user indicating acceptance of said offer.
